(19) United States
(12) Patent Application Publication
(10) Pub. No.: US 2002/0092180 A1
(43) Pub. Date: Jul. 18, 2002

(54) Cookie cutter for simultaneously cutting a plurality of cookies

(76) Inventor: Anthony Tomasulo, Norwalk, CT (US)

Correspondence Address: ST. ONGE STEWARD JOHNSTON & REENS, LLC, 986 BEDFORD STREET, STAMFORD, CT, 06905-5619, US

(21) Appl. No.: 10/043,509

(22) Filed: Jan. 11, 2002

Related U.S. Application Data
(60) Provisional application No. 60/262,509, filed on Jan. 18, 2001.

(51) Int. Cl. A21C 5/08

(52) U.S. Cl. 30/316; 30/315; 30/114

(57) ABSTRACT

A cookie cutter having a plurality of walls arranged to define a plurality of shapes, each of the plurality of shapes having substantially the same configuration, is provided. Each of the plurality of shapes shares at least one point of contact with at least one adjacent shape of the plurality of shapes in order to strengthen the walls while providing little space between the plurality of shapes which results in cookie dough waste. At least some of the points of contact may comprise shared edges, which provide substantially no space between the plurality of shapes which results in cookie dough waste. Preferably, at least two points of contact, or at least one point of contact and at least one shared edge, are provided.

### RELATED APPLICATIONS

This patent application claims the benefit of, under Title 35, United States Code, Section 119(e), U.S. Provisional Patent Application No. 60/262,509, filed Jan. 18, 2001.

### FIELD OF THE INVENTION

The present invention relates to an improved cookie cutter design, and more particularly to an improved cookie cutter design which allows for the simultaneous cutting of a plurality of cookies having a substantially identical shape.

### BACKGROUND OF THE INVENTION

Cookie cutting devices are well known. Such devices have long been used as an effective and efficient means of cutting cookie dough into individual cookies, and more particularly into cookies having interesting and desirable shapes. However, although the prior art is highly developed, certain deficiencies in this general area exist.

Traditionally known cookie cutters, which have been used for many years, are formed from a piece of relatively thin material, such as a metal or plastic material, having a periphery which corresponds to the desired shape of the finished cookie. In order to create cookies using such devices, the cookie dough is made and then rolled into a flat sheet. Next, the baker presses the cookie cutter into the sheet of cookie dough in order to cut a cookie, having a shape corresponding to the shape of the cookie cutter, from the sheet of cookie dough. The cut cookie is then removed from the sheet of cookie dough.

This process is repeated until all pieces of the sheet of cookie dough material which have not yet been cut are smaller than the shape of the cookie cutter. This left-over cookie dough material (i.e., the waste) is then typically re-rolled into another flat sheet of cookie dough material which, of course, has a smaller area than the original sheet, as a portion of the cookie dough material has already been removed in the form of cut cookies. More cookies are cut as described above, and the waste is again re-rolled into another, yet smaller, sheet of cookie dough material. This process is repeated until the sheet of cookie dough material created from the waste from the previous cutting iteration is too small to be cut into a cookie having the desired shape.

This process is time consuming, as the user is required to cut one cookie at a time and is required to repeatedly re-roll the waste for further cutting. An alternative would be to simply disregard the waste, which would be inefficient, and which would still be time-consuming, as cutting the cookies from the original sheet of cookie dough material must still be performed one at a time. A further possibility would be for the baker to carefully plan the positioning of the cookies cut from the original sheet of cookie dough material. However, such planning may be difficult, particularly when cookies having relatively complex shapes are being cut, and the process would be even more time-consuming, as not only would the baker still be required to cut one cookie at a time, but he/she must also carefully plan the positioning of the cuts on the sheet of cookie dough material.

In light of the above deficiencies, previous attempts have been made to improve upon the traditional cookie cutter design. U.S. Pat. No. 5,579,582 to Carlson, for example, discloses a puzzle cookie cutter which includes a cutting die holder and at least one cutting die removably securable in the holder. The die or dies provide for the cutting of cookie dough, batter, or the like into several separate, irregularly shaped and sized interfitting pieces, which pieces may be reassembled as a puzzle after baking to provide entertainment for the consumer of the cookie. The dies may be provided having an outer regular or irregular geometric shape, animal or other caricature or representation, and/or any alphanumeric character, as desired. The dies are also provided such that each of the pieces to be cut are unique, so that the pieces will not be confused with one another when the consumer is trying to assemble the puzzle. The die or dies may also provide for the spaced apart separation of the cut dough or batter, to allow for expansion or flow of the batter or dough during the baking process, in order that the baked pieces will have a close fit with one another without interference. The cut pieces may be baked adjacent one another on a sheet or pan and decorated after the baking process as desired, then separated randomly to provide a challenge akin to that of the assembly of a relatively simple jigsaw or picture puzzle, in addition to the enjoyment of eating the baked cookie pieces.

A disadvantage of this prior art reference, however, is that cookies are cut into several separate, irregularly shaped and sized interfitting pieces. While such may be useful if one desires to create a jigsaw puzzle, such is of no use if one desires to cut a plurality of cookies having substantially the same shape. Moreover, the provision of a spaced apart separation of the cut dough or batter to allow for expansion or flow of the batter or dough during the baking process results in a substantial amount of undesirable waste.

What is desired, therefore, is a cookie cutter which simultaneously cuts a plurality of cookies, which allows cookies having identical shapes to be cut, which allows for a plurality of cookies to be cut faster than by using traditional designs, which produces less waste of cookie dough than known designs, and which does not require the careful planning of the locations for cutting the cookies.

### SUMMARY OF THE INVENTION

Accordingly, it is an object of the present invention to provide a cookie cutter which simultaneously cuts a plurality of cookies.

Another object of the present invention is to provide a cookie cutter having the above characteristics and which allows cookies having identical shapes to be cut.

A further object of the present invention is to provide a cookie cutter having the above characteristics and which allows for a plurality of cookies to be cut faster than by using traditional designs.

Still another object of the present invention is to provide a cookie cutter having the above characteristics and which produces less waste of cookie dough than known designs.

Yet a further object of the present invention is to provide a cookie cutter having the above characteristics and which does not require the careful planning of the locations for cutting the cookies.

These and other objects of the present invention are achieved by provision of a cookie cutter having a plurality of walls arranged to define a plurality of shapes, each of the plurality of shapes having substantially the same configuration. Each of the plurality of shapes shares at least one point of contact with at least one adjacent shape of the plurality of shapes in order to strengthen the walls while providing little space between the plurality of shapes which results in cookie dough waste. At least some of the points of contact may comprise shared edges, which provide substantially no space between the plurality of shapes which results in cookie dough waste. Preferably, at least two points of contact, or at least one point of contact and at least one shared edge are provided.

The shapes may be integrally formed at the at least one point of contact or along the at least one shared edge, or they may be joined together at the at least one point of contact or along the at least one shared edge by a joining technique such as soldering, brazing, welding, adhering, or combinations of these. The walls may be formed of a metal sheet material., such as tin, copper, brass, stainless steel, or combinations of these, or may be formed of a plastic material.

The invention and its particular features and advantages will become more apparent from the following detailed description considered with reference to the accompanying drawings.

### BRIEF DESCRIPTION OF THE DRAWINGS

FIG. 1 is an isometric view of a cookie cutter in accordance with one embodiment of the present invention, in which each of a plurality of shapes shares at least one point of contact with at least one other of the plurality of shapes;

FIG. 2 is a top plan view of a cookie cutter in accordance the embodiment of the present invention shown in FIG. 1;

FIGS. 3A-3F are top plan views of a cookie cutter in accordance another embodiment of the present invention in which each of a plurality of shapes shares at least one common edge with at least one other of the plurality of shapes; and

FIG. 4 is a top plan view of a cookie cutter in accordance another embodiment of the present invention in which each of a plurality of shapes shares at least one common edge and at least one point of contact with at least one other of the plurality of shapes.

### DETAILED DESCRIPTION OF AN EMBODIMENT OF THE INVENTION

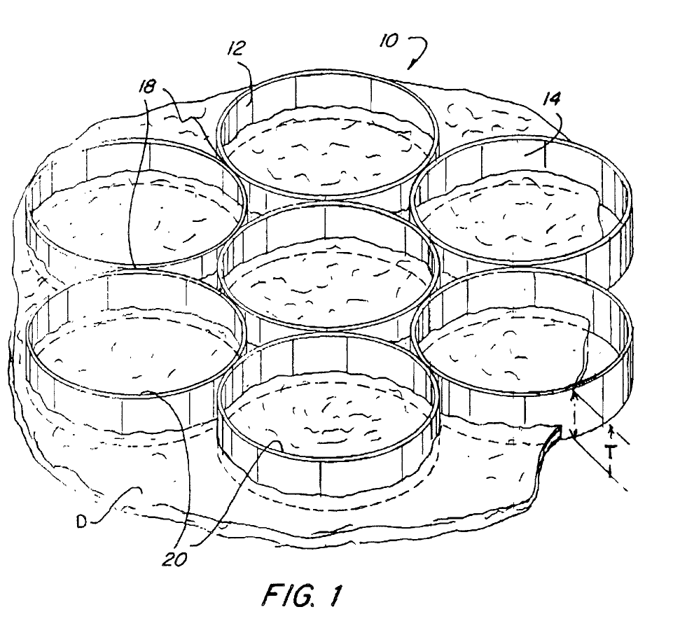

Referring to FIG. 1, a cookie cutter 10 in accordance with the present invention is shown. The cookie cutter 10 includes a plurality of walls 12, which are arranged to define a plurality of shapes 14 having substantially the same configuration, in the case of FIG. 1, these shapes 14 being circles. Walls 12 of cookie cutter 10 are typically formed of a thin metal (such as tin, copper or stainless steel) or plastic, as is known in the art of single-cookie cutters. Moreover, walls 12 have a thickness T which may range from a fraction of an inch to over 2 or more inches, also as is known in the art of single-cookie cutters. It is desirable that the thickness T of walls 12 be greater than the thickness of the sheet of cookie dough material D, and preferably that the thickness T of walls 12 be substantially greater than the thickness of the sheet of cookie dough material D so as to facilitate grasping of the cookie cutter 10 by the baker.

In one embodiment shapes 14 share at least one, and preferably at least two, points of contact 18 with at least one adjacent shape 14. Such allows for the walls 12 of cookie cutter 10 to be strengthened, while providing very little space between shapes 14 which would result in cookie dough waste. Shapes 14 may be integrally formed at points of contact 18, or may be joined together at points of contact 18 by soldering, brazing, welding, adhesives, or the like.

With respect to the configuration shown in FIG. 1, seven circles 20 are arranged such that each circle 20 shares at least three points of contact 18 with adjacent circles 20. It should be understood, however, that the number of circles 20 can be varied, so long as at least two are provided, and that circles 20 can be arranged in substantially any configuration, so long as each circle 20 shares at least one point of contact 18 with at least one adjacent circle 20.

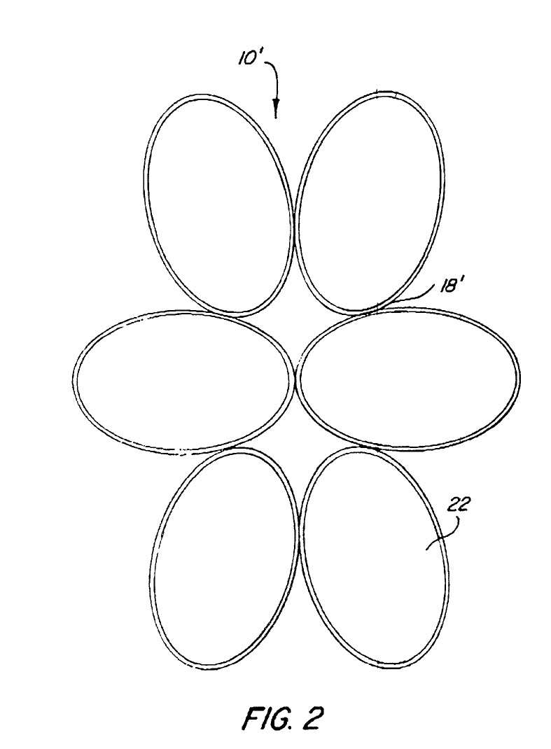

FIG. 2 illustrates a cookie cutter 10′ which includes six ovals 22 which are arranged such that each oval 22 shares at least two points of contact 18′ with adjacent ovals 22. It should be understood, however, that similar to the case described above with respect to FIG. 1, the number of ovals 22 can be varied, so long as at least two are provided, and that ovals 22 can be arranged in substantially any configuration, so long as each oval 22 shares at least one point of contact 18′ with at least one adjacent oval 22.

In another embodiment shapes 14″ share at least one, and preferably at least two, common edges 16 with at least one adjacent shape 14″. Such allows for the walls 12″ of cookie cutter 10″ to be strengthened, while providing substantially no space between shapes 14″ which would result in cookie dough waste. Shapes 14″ may be integrally formed along common edges 16 or may be joined together along common edges 16 by soldering, brazing, welding, adhesives, or the like.

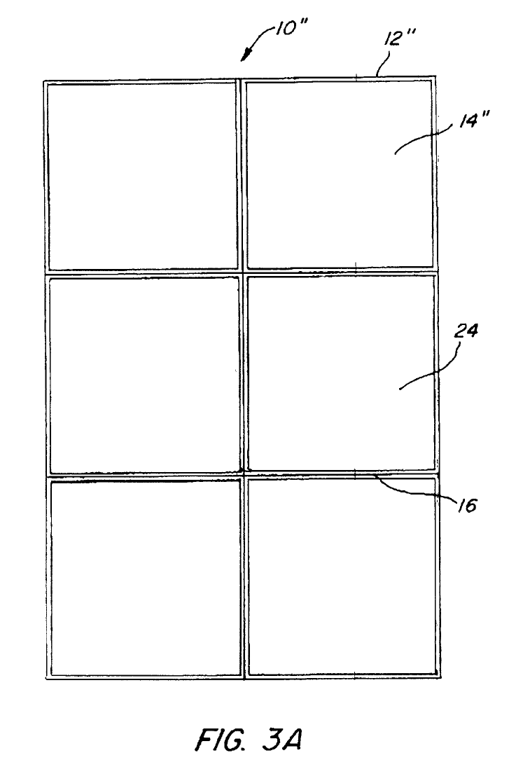

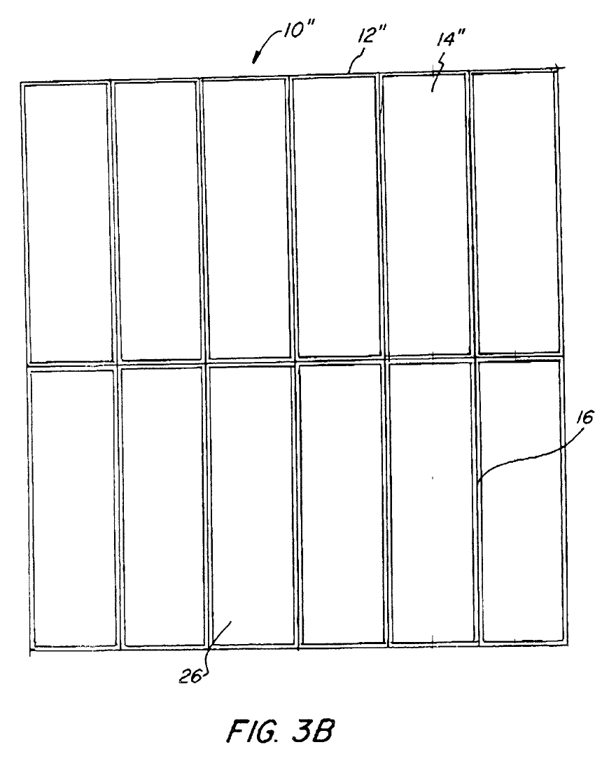

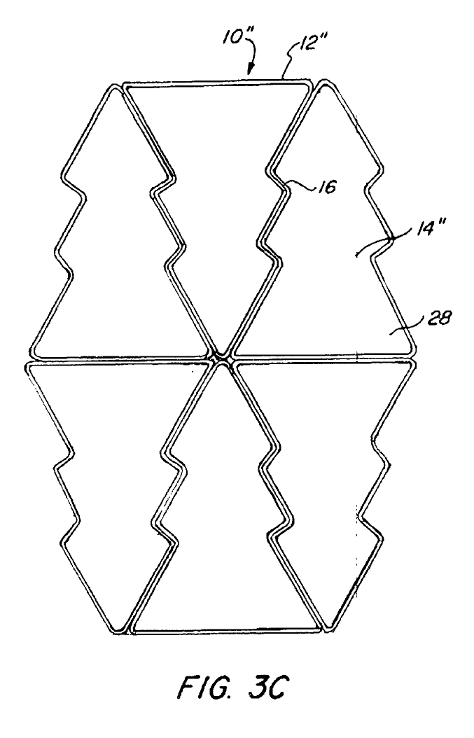

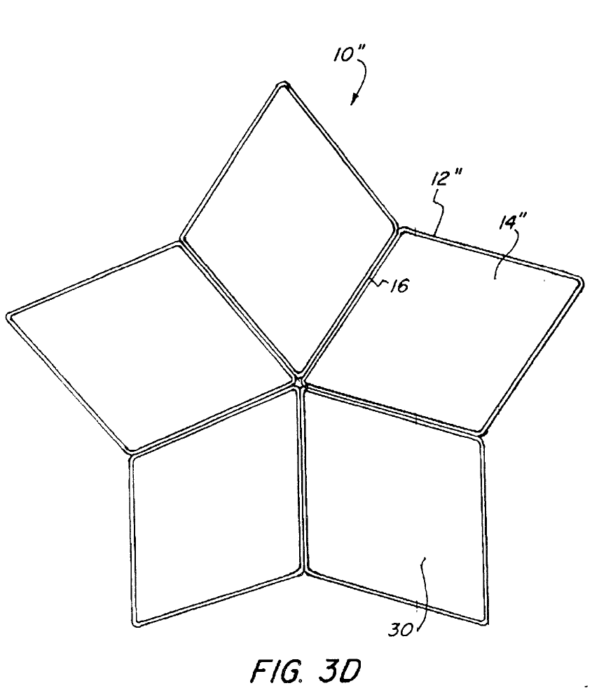

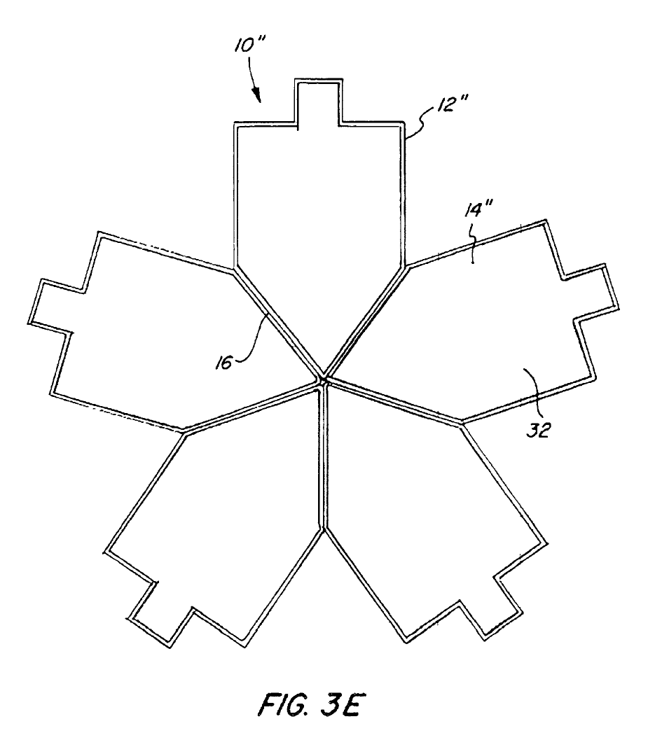

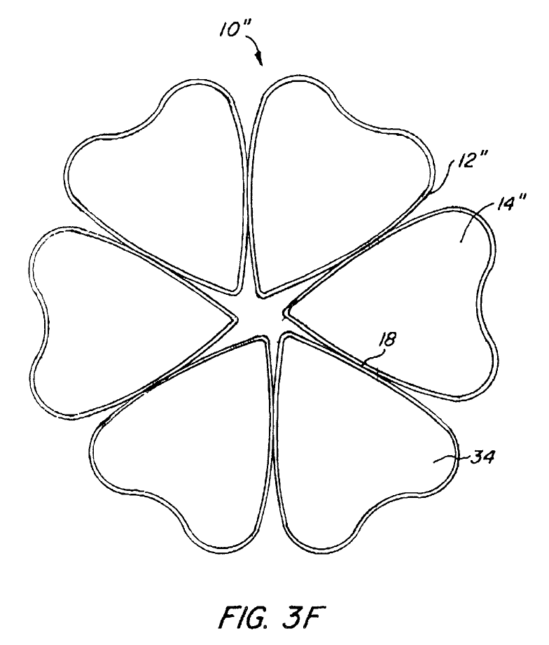

With respect to the configurations shown in FIGS. 3A and 3B respectively, six squares 24 are arranged such that each square 24 shares at least two common edges 16 with adjacent squares 24, and twelve rectangles 26 are arranged such that each rectangle 26 shares at least two common edges 16 with adjacent rectangles 26. It should be understood that more complex shapes are also contemplated, such as are illustrates in FIGS. 3C-3F which show, respectively, six Christmas trees 28, five diamonds 30, five dreidels 32 and six hearts 34, each of which shares at least two common edges 16 with adjacent shapes 14″. It should be understood, however, that the number of shapes 14″ in each of the embodiments shown in FIGS. 3A-3F can be varied, so long as at least two are provided, and that shapes 14″ can be arranged in substantially any configuration, so long as each shape 14″ shares at least one common edge 16 with at least one adjacent shape 14″.

In yet another embodiment shapes 14′″ share at least one common edge 16 with at least one adjacent shape 14′″ and at least one point of contact 18 with at least one adjacent shape 14′″. Such allows for the walls 12′″ of cookie cutter 10′″ to be strengthened, while providing substantially very little, or no, space between shapes 14′″ which would result in cookie dough waste. Shapes 14′″ may be integrally formed along common edges 16 and points of contact 18 or may be joined together along common edges 16 and at points of contact 18 by soldering, brazing, welding, adhesives, or the like.

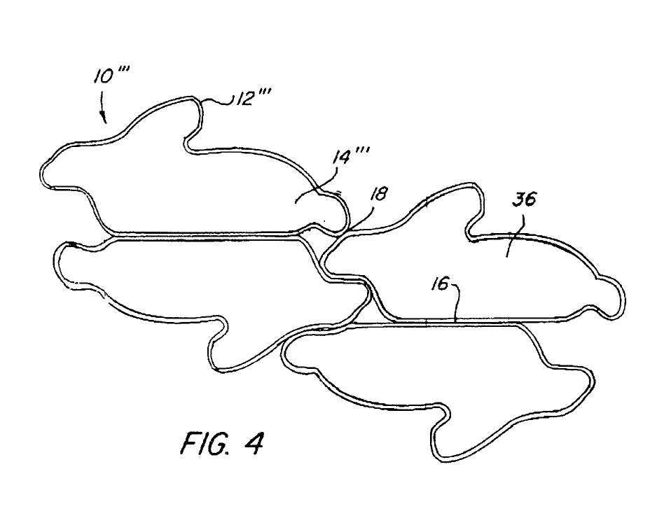

With respect to the configurations shown in FIG. 4, four bunnies 36 are arranged such that each bunny 36 shares at least one common edge 16 and at least one point of contact 18 with adjacent bunnies 36. It should be understood, however, that the number of bunnies 36 can be varied, so long as at least two are provided, and that bunnies 36 can be arranged in substantially any configuration, so long as each bunny 36 shares at least one common edge 16 and at least one point of contact 18 with at least one adjacent bunny 36.

The present invention, therefore, provides a cookie cutter which simultaneously cuts a plurality of cookies, which allows cookies having identical shapes to be cut, which allows for a plurality of cookies to be cut faster than by using traditional designs, which produces less waste of cookie dough than known designs, and which does not require the careful planning of the locations for cutting the cookies.

Although the invention has been described with reference to a particular arrangement of parts, features and the like, these are not intended to exhaust all possible arrangements or features, and indeed many other modifications and variations will be ascertainable to those of skill in the art. More particularly, it is contemplated that cookies having a substantially infinite number of shapes can be cut using a cookie cutter in accordance with the present invention.

What is claimed is:

1. A cookie cutter comprising:
a plurality of walls arranged to define a plurality of shapes, each of the plurality of shapes having substantially the same configuration; and
wherein each of the plurality of shapes shares at least one point of contact with at least one adjacent shape of the plurality of shapes in order to strengthen the walls while providing little space between the plurality of shapes which results in cookie dough waste.

2. The cookie cutter of claim 1 wherein at least some of the points of contact comprise shared edges.

3. The cookie cutter of claim 1 wherein the at least one point of contact comprises at least two points of contact.

4. The cookie cutter of claim 1 wherein the shapes are integrally formed at the at least one point of contact.

5. The cookie cutter of claim 1 wherein the shapes are joined together at the at least one point of contact by a joining technique selected from the group consisting of soldering, brazing, welding, adhering, or combinations of these.

6. The cookie cutter of claim 1 wherein the walls are formed of a metal sheet material.

7. The cookie cutter of claim 6 wherein the metal is selected from the group consisting of tin, copper, brass, stainless steel, or combinations of these.

8. The cookie cutter of claim 1 wherein the walls are formed of a plastic material.

9. A cookie cutter comprising:
a plurality of walls arranged to define a plurality of shapes, each of the plurality of shapes having substantially the same configuration; and
wherein each of the plurality of shapes shares at least one common edge with at least one adjacent shape of the plurality of shapes in order to strengthen the walls while providing substantially no space between the plurality of shapes which results in cookie dough waste.

10. The cookie cutter of claim 9 wherein the at least one common edge comprises at least two common edges.

11. The cookie cutter of claim 9 wherein the shapes are integrally formed along the at least one common edge.

12. The cookie cutter of claim 9 wherein the shapes are joined together along the at least one common edge by a joining technique selected from the group consisting of soldering, brazing, welding, adhering, or combinations of these.

13. The cookie cutter of claim 9 wherein the walls are formed of a metal sheet material.

14. The cookie cutter of claim 10 wherein the metal is selected from the group consisting of tin, copper, brass, stainless steel, or combinations of these.

15. The cookie cutter of claim 9 wherein the walls are formed of a plastic material.

16. A cookie cutter comprising:
a plurality of walls arranged to define a plurality of shapes, each of the plurality of shapes having substantially the same configuration; and
wherein each of the plurality of shapes shares at least one common edge with at least one adjacent shape of the plurality of shapes, and at least one point of contact with at least one adjacent shape of the plurality of shapes, in order to strengthen the walls while providing little space between the plurality of shapes which results in cookie dough waste.

17. The cookie cutter of claim 16 wherein the shapes are integrally formed along the at least one common edge and at the at least one point of contact.

18. The cookie cutter of claim 16 wherein the shapes are joined together along the at least one common edge and at the at least one point of contact by a joining technique selected from the group consisting of soldering, brazing, welding, adhering, or combinations of these.

19. The cookie cutter of claim 16 wherein the walls are formed of a metal sheet material.

20. The cookie cutter of claim 19 wherein the metal is selected from the group consisting of tin, copper, brass, stainless steel, or combinations of these.

21. The cookie cutter of claim 16 wherein the walls are formed of a plastic material.
